(19) United States
(12) Patent Application Publication
(10) Pub. No.: US 2013/0016867 A1
(43) Pub. Date: Jan. 17, 2013

(54) EARPIECE HAVING MULTIPLE AUDIO CHAMBERS

(71) Applicants: Li-shu Xi, Shenzhen (CN); Shi-min Qu, Shenzhen (CN); Xing-zhi Huang, Shenzhen (CN)

(72) Inventors: Li-shu Xi, Shenzhen (CN); Shi-min Qu, Shenzhen (CN); Xing-zhi Huang, Shenzhen (CN)

(73) Assignees: AAC TECHNOLOGIES HOLDINGS INC., Cayman Islands (GB); AAC ACOUSTIC TECHNOLOGIES (SHENZHEN) CO., LTD., Shenzhen (CN)

(21) Appl. No.: 13/548,494

(22) Filed: Jul. 13, 2012

(30) Foreign Application Priority Data
Jul. 14, 2011 (CN) 201110198328.5

(51) Int. Cl. H04R 1/10

(52) U.S. Cl. 381/374

(57) ABSTRACT

An earpiece is disclosed. The earpiece includes a housing forming a volume, a number of sound holes arranged in the front end and rear end of the housing, a sound generator accommodated in the chamber for dividing the volume into several parts isolated with each other, and a wire electrically connected to the sound generator for providing audio signals to the sound generator. Each of several parts of the volume communicates with the outside of the earpiece via a corresponding sound hole in the housing.

### RELATED PATENT APPLICATION

This application claims the priority benefit of Chinese Patent Application Filing Serial Number CN 201110198328.5, the disclosure of which is herein incorporated by reference in its entirety.

### FIELD OF THE INVENTION

The present disclosure generally relates to the art of sound transmitters, and more particularly, to an earpiece including a sound generator with multiple audio chambers.

### DESCRIPTION OF RELATED ARTS

In recent years, portable audio playback apparatuses have widely proliferated. The audio playback apparatuses output audio from earphones, for example, and thereby provide the sound to users. For the earphones, various types are available and the taste of earphones often varies from user to user. As an example of the earphones, numbers of earphones, called earplug type (canal type), are commercialized in which an earpiece is attached to a front end of a sound conduit.

A related earpiece generally includes a housing and a sound generator accommodated in the housing. The sound generator includes a diaphragm and a frame for supporting the diaphragm. The frame is divided into two parts by the diaphragm. The two parts are usually called front volume and rear volume. However, the only two volumes limit the bandwidth of the frequency of the audio signals. And the bandwidth of the frequency of the audio signals is restricted in high frequency and low frequency. Intermediate frequency and extra low frequency of the audio signals are lost or are not performed accurately, which affects the sound quality required by the users.

So, it is necessary to provide a new earpiece for solving the problems mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an earpiece in accordance with an exemplary embodiment of the present disclosure.

FIG. 2 is an isometric view of the earpiece in FIG. 1, from another aspect.

FIG. 3 is a cross-sectional view of the earpiece in FIG. 1.

FIG. 4 is an enlarged cross-sectional view of a sound generator of the earpiece in FIG. 3.

### DETAILED DESCRIPTION OF AN EXEMPLARY EMBODIMENT

While the invention is susceptible of embodiments in many different forms, there is shown in the drawings and will herein be described in detail embodiment of the invention with the understanding that the present disclosure is to be considered as an exemplification of the principles of the invention and is not intended to limit the broad aspect of the invention to the embodiment illustrated.

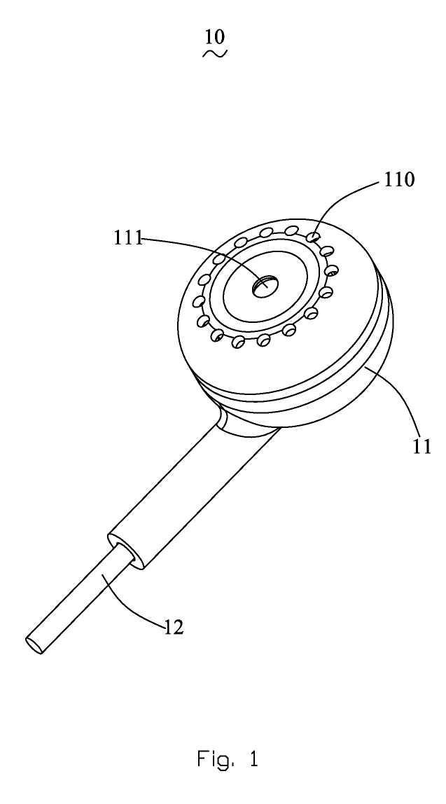

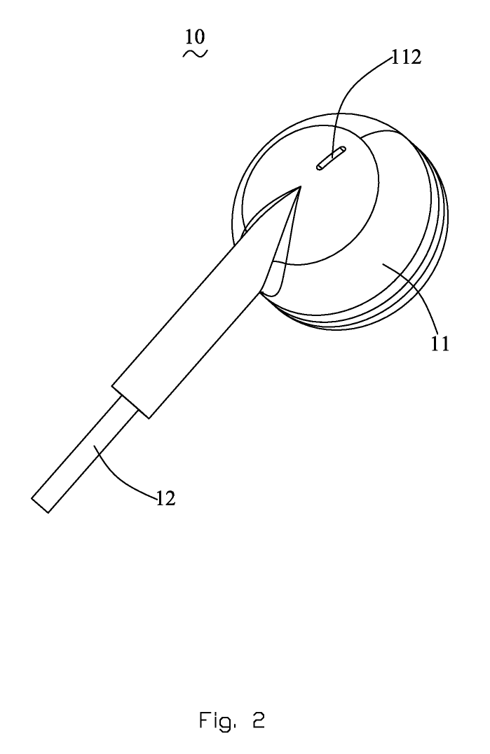

Referring to FIGS. 1 and 2, an earpiece 10, in accordance with an exemplary embodiment of the present disclosure, includes a housing 11 for accommodating a sound generator therein (the sound generator will be described in detail below) and a wire for connecting the sound generator to an external device that provides audio signals. The housing 11 includes a plurality of sound holes for transmitting the sound produced by the sound generator to the user's ear. In this embodiment, the sound holes comprises a plurality of first sound holes 110 in the front end of the housing, a second sound hole 111 surrounded by the first sound holes 110, and a third sound hole 112 in the rear end of the housing 11. The amount and shape of the sound hole may be adjusted or changed according to the requirements of design, manufacturing, or individual user.

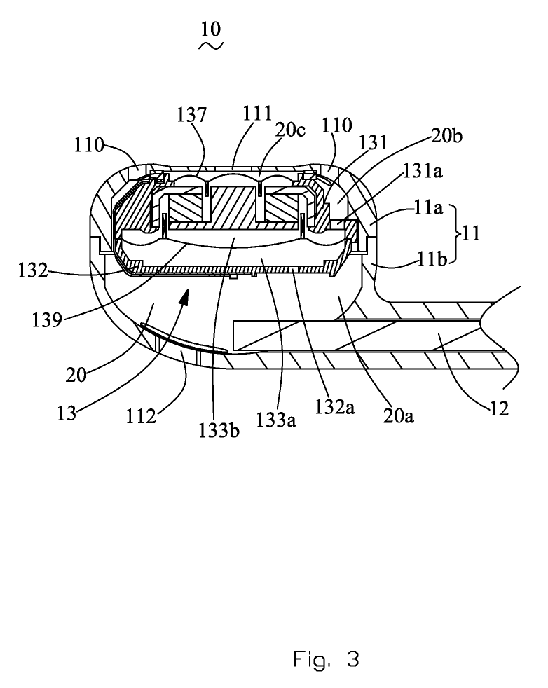

Referring to FIG. 3, which is a cross-sectional view of the earpiece in FIG. 1, the housing 11 includes a first part 11a and a second part 11b engaged with the first part 11a for forming a volume 20 for accommodating a sound generator 13 therein. The sound generator 13 is positioned in the volume 20 by mechanical connections with the housing 11. In this embodiment, the sound generator 13 engages with the first part 11a of the housing 11. In fact, in alternative embodiments, the sound generator 13 may be engaged with the second part 11b of the housing 11, or engaged with both of the first part 11a and the second part 11b. The first sound holes 110 and the second sound hole 111 are formed in the first part 11a of the housing 11, and the third sound hole 112 is formed in the second part 11b of the housing. The first and second sound holes 110, 111 are used to communicate the volume 20 with the outside from the front end of the housing 11, and the third sound hole 112 is used to communicate the volume 20 with the outside from the rear end of the housing 11. The second part 11b of the housing 11 includes a part for assembling with the wire 12 for obtaining audio signals via the wire 13.

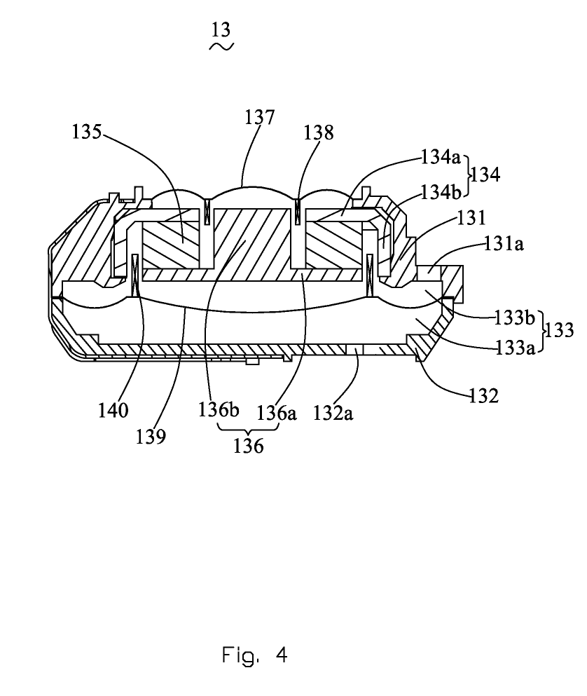

Referring to FIG. 4, which is a cross-sectional view of the sound generator 13, the sound generator 13 includes a frame 131, a cover engaged with the frame 131 for forming a chamber 133, a first plate 134 engaged with the frame 131, a magnet 135 positioned on the first plate 134 with a surface attached to the first plate 134, and a second plate 136 attached to another surface of the magnet 135. The combination of the first plate 134, the second plate 136 and the magnet 135 serves as a magnetic circuit.

The first plate 134 includes a bottom 134a for engaging with a part of the frame 131, and a side 134b for engaging with another part of the frame 131. The magnet 135 is positioned on the bottom 134a. The bottom 134a has a central hole, and the magnet 135 also forms a central hole aligned with the central hole of the bottom 134a. The second plate 136 includes a base 136a attached to the magnet 135, and a protrusion 136b extending from the base 136a into the central holes of the magnet 135 and the bottom 134a of the first plate 134. While assembled, the magnet 135 is sandwiched between the bottom 134a of the first plate 134 and the base 136a of the second plate 136, thereby forming a first magnetic gap between the outer surface of the protrusion 136b of the second plate 136 and the inner surface of the magnet 135, and a second magnetic gap between the outer surface of the magnet 135 and the inner surface of the side 134b of the first plate.

The sound generator 13 further includes a first diaphragm 137 supported by the frame 131, a first coil 138 connected with the first diaphragm 137 and partially received in the first magnetic gap, a second diaphragm 139 supported by the frame 131 or the cover 132, and a second coil 140 connected with the second diaphragm and partially received in the second magnetic gap.

The chamber 133 is divided into two parts by the second diaphragm 139. The two parts includes a first chamber 133a and a second chamber 133b. The frame 131 further forms a frame aperture 131 for communicating with the second chamber 133b, and the cover 132 further forms a cover aperture 132a communicating with the first chamber 133a.

Referring to FIGS. 3 and 4, while the sound generator 13 is located in the volume 20 formed by the first part 11a and second part 11b of the housing 11, the volume 20 is divided into a first volume 20a between the cover 132 of the sound generator 13 and the second part 11b of the housing 11, a second volume 20b between the frame 131 a of the sound generator 13 and the first part 11a of the housing 11, and a third volume 20c between the first diaphragm 137 and the first part 11a of the housing 11.

The first volume 20a communicates with the outside of the earpiece via the third sound hole 112, and communicates with the first chamber 133a via the cover aperture 132a. The second chamber 133b communicates with the second volume 20b via the frame aperture 131a, and the second volume 20b communicates with the outside of the earpiece via the first sound holes 110. The Third volume 20c communicates with the outside of the earpiece via the second sound hole 111.

By virtue of the configuration of the volume 20 and the chamber 133, the sound waves produced by the second diaphragm 139 corresponding to low frequency signals in the first chamber 133a are transmitted to the first volume 20a via the cover aperture and then to the outside of the earpiece via the third sound hole 112, the sound waves produced by the second diaphragm 139 corresponding to intermediate and low frequency signals in the second chamber 133b are transmitted to the second volume 20b via the frame aperture 131a and then to the outside of the earpiece via the first sound holes 110, the sound waves produced by the first diaphragm 137 corresponding to high frequency signals in the third volume 20c are transmitted to the outside of the earpiece via the second sound hole 111. The cooperation between the chamber and the volume broads the bandwidth of the frequency response of the earpiece and improve the sound performance accordingly.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. An earpiece, comprising:
a housing forming a volume, a plurality of sound holes arranged in the front end and rear end of the housing;
a sound generator accommodated in the chamber for dividing the volume into a first volume, a second volume and a third volume isolated with each other;
a wire electrically connected to the sound generator for providing audio signals to the sound generator; wherein
each of the first volume, the second volume and the third volume communicates with the outside of the earpiece via a corresponding sound hole in the housing.

2. The earpiece in claim 1, wherein the sound generator includes a chamber, a magnetic circuit including a first magnetic gap located in the chamber, a first coil partially received in the magnetic gap, and a first diaphragm driven by the coil for producing sound waves, the chamber is divided by the first diaphragm into a first chamber communicating with the first volume, and a second chamber communicating with the second volume.

3. The earpiece in claim 2, wherein the sound generator further includes a frame, a cover engaging with the frame for forming the chamber, the cover includes a cover aperture for communicating the first chamber with the first volume, and the frame includes a frame aperture for communicating the second chamber with the second volume.

4. The earpiece in claim 3, wherein the magnetic circuit of the sound generator further includes a second magnetic gap for partially receiving a second coil connecting with a second diaphragm, the third volume is formed between the second diaphragm and the housing.

5. The earpiece in claim 1, wherein the sound holes includes a plurality of first sound holes, a second sound hole surrounded by the first sound holes, and a third sound hole formed in the rear end opposed from the first and second sound holes.

6. The earpiece in claim 5, wherein the housing includes a first part forming the second volume with the frame of the sound generator and forming the third volume with the second diaphragm, a second part engaging with the first part and forming the first volume with the cover of the sound generator.

7. The earpiece in claim 6, wherein the first and second sound holes are arranged in the first part, and the third sound hole is formed in the second part.

8. An earpiece, comprising:
a housing forming a volume;
a sound generator accommodated in the volume for dividing the volume into a first volume, a second volume and a third volume, each of the first volume, the second volume and the third volume communicating with the exterior side of the housing via a corresponding hole arranged in the housing from different directions.

9. The earpiece in claim 8, wherein two of the first volume, the second volume and the third volume communicate with the exterior side of the housing via holes arranged in one direction, and the other communicates with the exterior side of the housing via the hole in a converse direction.

10. The earpiece in claim 8, wherein the housing further includes a first part positioning the sound generator and forming two of the first volume, the second volume and the third volume, and a second part engaging with the first part and forming the other of the first volume, the second volume and the third volume.

11. The earpiece in claim 10 further comprising a wire fixed by the second part for electrically connecting with the sound generator.

12. An earpiece, comprising:
a housing forming a volume therein;
a sound generator accommodated in the volume and dividing the volume into a plurality of spaces corresponding to low frequency audio signals, intermediate frequency audio signals, and high frequency audio signals, respectively, each of the spaces being communicated with the exterior side of the housing via a plurality of holes arranged in the housing.
